(19) United States
(12) Patent Application Publication
(10) Pub. No.: US 2003/0059513 A1
(43) Pub. Date: Mar. 27, 2003

(54) Process for combining certain ingredients to create barbeque sauce

(76) Inventor: Johnny Norris, Hopkins, SC (US)

Correspondence Address: Johnny Norris, 212 Pointer Drive, Hopkins, SC, 29061, US

(21) Appl. No.: 09/963,697

(22) Filed: Sep. 27, 2001

(51) Int. Cl. A23L 1/238

(52) U.S. Cl. 426/589

(57) ABSTRACT

This invention relates to creating barbeque sauce through the combination of certain ingredients in a specific sequence at room temperature. Combination of the ingredients in accordance with procedures outlined in the invention produces a unique food product with a rough, continuous aqueous phase with discreet vegetable particles dispersed therein. By combining sugar, tomato ketchup, mustard, sweet green relish, crushed red pepper and water through a cold processing technique, a new food product is produced which has utility as a barbeque sauce. This invention is advantageously adaptable from residential to commercial food preparation settings and is easily adaptable to suit the taste of the most discriminating consumers.

### PURPOSE

This is an application for a patent to protect the combination of certain ingredients to create a special barbeque sauce. The process involves mixing of certain specified ingredients in equal quantities and measurements through the use of a unique cold processing technique so as to create a substance with an aqueous nature and unique taste and textural context.

Ingredients (makes four and one half gallons)

| | |
|---|---|
| Sugar (5 pounds) | Sweet Green Relish (½ gallon) |
| Tomato Ketchup (2 gallons) | Crushed Red Pepper (½ cup) |
| Mustard (1 gallon) | Water (3 quarts, 1 cup, and ⅓ cup) |

### PROCESS

(1) Gather ingredients

(2) Allow ingredients to sit until they reach room temperature (approximately 72 degrees)

(3) Combine ingredients

(4) Combine relish, mustard, sugar, ketchup, water, and crushed red pepper in equal portions in a 5 gallon stainless steel bowl. Stir constantly as each ingredient is added. Stir ingredients until well blended. Bottle and store at room temperature or refrigerate. Refrigerate after use.

### INDUSTRY BACKGROUND

Currently, the U.S. and international markets have been inundated with literally hundreds of thousands of barbeque sauce recipes containing a variety of ingredients integrated in seemingly endless combinations. Careful and exhaustingly thorough market analysis reveals that nowhere does there appear to be a sauce recipe that utilizes the techniques, ingredients, or processes that give Rerun's Barbeque Sauce its unique, distinctive, and original flavor and texture. The process of integrating specific room temperature ingredients in equal portions through the use of cold processing techniques preserves the essential chemical nature and makeup of each individual ingredient and allows for the marriage of these unique properties upon application of the sauce during the cooking process. Rerun's Barbeque Sauce, when applied to cooked meats, poultry, or vegetables creates an original combination of spicy and sweet flavoring that enhances and compliments. Additionally, the sauce makes an excellent dip for raw vegetables, boiled shrimp, oysters on the half shell and other cold specialty dishes.

There is no other sauce on the market with the distinctive and original taste combination of Rerun's Barbeque Sauce. The sauce, when applied to meats, poultry, and seafood during grilling releases an aromatic and flavorful sensation that is pleasing to taste and smell. When applied to meats, poultry, and seafood over any open grill, the cold processed ingredients release their chemical properties and meld together in a slightly congealed coating to seal in and enhance the natural flavors of meats, poultry, and seafood.

Rerun's Barbeque Sauce is comprised of a combination of soft, pickled vegetable particles suspended in slightly acidic aqueous base through a cold processing technique. The processing entails combining the rough vegetable particles with an otherwise smooth sauce base through cold processing techniques to create a rough textured sauce with a slightly acidic and sweet property.

### SUMMARY

The principal objects of the invention are to provide a new food product of the type having a rough, continuous aqueous phase with discrete vegetable particles dispersed therein, and to provide a cold processing technique for preparing the ingredients.

These objects and others are achieved according to the present invention which provides a new food product of the type having a rough, continuous aqueous phase with discrete vegetable particles dispersed therein, wherein the process entails: combining sugar, tomato ketchup, mustard, sweet green relish, crushed red pepper and water through a cold processing technique to create a food product as herein described.

### DETAILED DESCRIPTION OF THE INVENTION

The invention provides food products in a wide variety of formulations and consistencies, which have a rough, continuous aqueous phase with discrete vegetable particles, dispersed therein. The vegetable particles are prepared in a manner that gives them a soft but consistent pulpy texture in the mouth and a pleasing, rough and bulky appearance to the eye. The vegetable particles are texturally stable and can withstand long periods of storage and commercial processing conditions.

The present invention has its widest applicability to fluid food products that will typically be described as liquid. These are products that would normally flow under their own weight when placed on a horizontal surface. Some examples of these products include: barbeque sauce, ketchup, mustard, etc.

The discovery that the certain type of vegetable particles used in the present invention would remain stable during cold processing and are capable of withstanding commercial processing techniques enables the introduction of a nutritionally valuable product to certain aqueous products at a low cost. The introduction of other bulk products in certain amounts, which do not affect the structural integrity of the rough, most vegetable particles, used in this invention may also be introduced for their particular flavor, texture, or appearance. Examples of other vegetable particles, which may be included, are dried onions, dried garlic, dried celery, dried parsley, etc.

The discovery of the present invention that the vegetable particles introduced herein will withstand the cold processing techniques employed in the invention while fresh vegetable particles will not, allows for the introduction of a new food product at a reasonable cost. All of the vegetable particles utilized in the invention have been commercially processed under strict commercial processing guidelines ensuring their stability and suitability for use in the food product industry. Minor amounts of other materials, which do not affect the structural or textural stability of the vegetable products, may be present. For example, small amounts of vinegar, salt, or other preservatives may be utilized in the invention for their known specific purposes.

The embodiment of the food product as a whole, which is herein described, consists of a combination of food products that are mixed at room temperature at certain specific intervals and sequence combinations to produce a unique aqueous based product. Once the ingredients have been combined in sequence, then the entire mixture should preferably be hand blended to achieve the desired appearance and texture.

The spices, flavors, and colors can be selected as desired for various end uses contemplated for the food product. The typical spices and flavors contemplated are onion powder, garlic powder, black pepper, white pepper, salt, paprika, and just about any other flavor desired. In many food products a slightly tangy taste is desired which may be achieved through the use of suitable acidulate. Many of those food acceptable acidulates known to the art can be employed in amounts effective to produce the desired degree of tangy taste. Included in these acidulates are acetic acid, vinegar, citric acid, malic acid, fumaric acid and the like.

What is claimed is:

1) A process for preparing a sauce having a pulpy and visibly lumpy texture wherein the improvement comprises:
(a) blending together sauce ingredients consisting of sugar, tomato ketchup, mustard, sweet green relish, crushed red pepper, and water wherein the relish and crushed red pepper act as pulp-stimulating particles;
(b) combining the sauce ingredients in by sequence by stirring at room temperature in a stainless steel bowl or other stainless steel container of at least five gallon capacity until all ingredients are well blended; and
(c) bottling the sauce.

2) An improved process according to claim 1 wherein five pounds of sugar, ½ gallon of sweet green relish, 2 gallons of tomato ketchup, 1 gallon of mustard, ½ cup of crushed red pepper, and 3 quarts, 1 cup and ⅓ cup of water are combined under conditions effective to provide a continuous lumpy sauce having discrete pulp-stimulating particles dispersed uniformly throughout.

3) An improved process according to claim 2 where the food product is a barbeque sauce.

4) A sauces product made by the process of claim 1.
